(19) United States
(12) Patent Application Publication
(10) Pub. No.: US 2017/0308875 A1
(43) Pub. Date: Oct. 26, 2017

(54) SYSTEMS AND METHODS FOR INITIATING PAYMENTS IN FAVOUR OF A PAYEE ENTITY

(71) Applicant: Visa International Service Association, San Francisco, CA (US)

(72) Inventors: Alan Joseph O'Regan, Cape Town (ZA); Horatio Nelson Huxham, Cape Town (ZA)

(73) Assignee: Visa International Service Association, San Francisco, CA (US)

(21) Appl. No.: 15/517,459

(22) PCT Filed: Nov. 17, 2015
(86) PCT No.: PCT/IB2015/058864

§ 371 Date: Apr. 6, 2017

(30) Foreign Application Priority Data
Nov. 18, 2014 (ZA) 2014/08444

(51) Int. Cl. G06Q 20/10; G06Q 20/40; G06Q 20/32; G06Q 40/02; G06Q 20/08

(52) U.S. Cl. CPC G06Q 20/102; G06Q 40/02; G06Q 20/085; G06Q 20/3223; G06Q 20/40

(57) ABSTRACT

A system and method for initiating payments in favour of a payee entity are provided. In a method conducted at a payment processor, an account creation request, the request including an identifier of a consumer is received from a payee entity. A financial account is registered for the payee entity in association with the consumer identifier and a consumer-specific account identifier of the financial account is provided. The consumer-specific account identifier is linked to the payee entity and consumer identifier and transmitted to a communication device of the consumer directly or via the payee entity so as to permit the consumer to initiate a payment in favour of the financial account of the payee entity by generating a transaction request message including the consumer-specific account identifier.

### CROSS REFERENCE TO RELATED APPLICATION

This application claims priority from South African provisional patent application number 2014/08444, filed on 18 Nov. 2014, which is incorporated by reference herein.

### FIELD OF THE INVENTION

This invention relates to systems and methods for initiating payments in favour of a payee entity.

### BACKGROUND TO THE INVENTION

A single consumer can often receive goods or services from a number of “billers” every month. Exemplary billers include utility providers, fixed line or mobile phone providers, cable or satellite television providers and the like. Such billers typically render monthly accounts for the goods or services rendered during that month, such accounts indicating an amount payable by the consumer. These accounts may be transmitted to the consumer either in the post or electronically over email or the like.

In order to pay the billers, the consumer must typically effect a bank transfer to a bank account of the biller, usually identified on the accounts. The consumer may also have to provide a specific reference such that the biller may identify the payment as having originated from that particular consumer. The consumer will probably also have to correctly enter the amount to be paid.

This process can thus be quite cumbersome and frustrating, especially where it must be repeated monthly for a number of billers.

The prior art has provided what may be termed a “bill aggregator” which interfaces between a consumer's bank account and a plurality of billers, enabling the consumer to effect payments to the billers.

However, such bill aggregators often interface to banking platforms in a bespoke fashion, increasing the complexity and difficulty experienced by financial institutions, maintaining such banking platforms, in implementing a bill aggregator's solution. This could mean that billers and financial institutions alike are less likely to make use of bill aggregators, due to increased cost and complexity.

This in turn could mean that consumers are left without convenient ways of making payments in favour of billers. Furthermore, unbanked consumers, being consumers not having access to bank accounts, may be unable to easily pay billers or bill aggregators, which may reduce ease of access to goods or services provided by such billers.

There is accordingly a need for a solution which addresses these and/or other problems, at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

According to a first aspect of the present invention there is provided a method for initiating payments in favour of a payee entity, the method being conducted at a payment processor and comprising: receiving, from a payee entity, an account creation request, the request including an identifier of a consumer; registering a financial account for the payee entity in association with the consumer identifier; providing a consumer-specific account identifier of the financial account; linking the consumer-specific account identifier to the payee entity and consumer identifier; and, transmitting the consumer-specific account identifier to a communication device of the consumer directly or via the payee entity so as to permit the consumer to initiate a payment in favour of the financial account of the payee entity by generating a transaction request message including the consumer-specific account identifier.

Receiving an account creation request may include one of: receiving a payee entity identifier with the account creation request; or generating a payee entity identifier.

The payment processor may execute a software architecture in which a single instance of software serves multiple tenants, and wherein the method includes registering the payee entity as a tenant.

Registering a financial account for the payee entity in association with the consumer identifier may transmit a request to an acquiring financial institution to register the financial account in association with the consumer identifier.

The method may include: receiving a transaction request message in respect of a transfer of funds from a financial account of the consumer to the payee entity, the transaction request message including the consumer-specific account identifier and an amount associated with the transfer of funds; identifying, using the consumer-specific account identifier, the financial account of the payee entity; and processing the transfer of funds against the financial account of the consumer and in favour of the financial account of the payee entity.

The consumer-specific account identifier may include routing information and payments made in favour of the financial account of payee entity may be routed via a payment processing network.

Identifying the financial account of the payee entity may include using the consumer-specific account identifier to identify a payee entity identifier and the consumer identifier.

Processing the transfer of funds may include: identifying an acquiring financial institution having registered the financial account; including the consumer identifier in the transaction request message; and, transmitting the transaction request message to the acquiring financial institution.

The method may include receiving a transaction response message from the acquiring financial institution, the transaction response message either confirming or denying the transaction.

The method may include a step of transmitting a payment confirmation message or payment denial message to the consumer.

The method may further include: receiving an account balance request from the consumer, the request including the consumer identifier; identifying the financial account associated with the consumer identifier; determining balance information of the financial account; and, transmitting the balance information to the consumer.

The method may also include: receiving a transaction request message in respect of a transfer of funds from a float account of an agent to the payee entity on behalf of the consumer, the transaction request message including the consumer-specific account identifier and an amount associated with the transfer of funds; identifying, using the consumer-specific account identifier, the financial account of the payee entity and an identifier of the consumer; processing the transfer of funds against the float account and in favour of the financial account of the payee entity; receiving a transaction response message either confirming or denying the transaction; and, transmitting a payment confirmation message or payment denial message to the communication device of the consumer such that the consumer may pay to the agent an amount of cash corresponding to the amount associated with the transfer of funds.

According to a second aspect of the present invention there is provided a method for initiating payments in favour of a payee entity, the method being conducted at a payment processor and comprising the steps of: receiving a transaction request message in respect of a transfer of funds from a float account of an agent to a payee entity on behalf of a consumer, the transaction request message including a consumer-specific account identifier of a financial account of the payee entity being associated with the consumer and an amount associated with the transfer of funds; identifying, using the consumer-specific account identifier, the financial account of the payee entity and an identifier of the consumer; processing the transfer of funds against the float account and in favour of the financial account; receiving a transaction response message either confirming or denying the transaction; and, transmitting a payment confirmation message or payment denial message to a communication device of the consumer such that the consumer may pay to the agent an amount of cash corresponding to the amount associated with the transfer of funds.

According to a third aspect of the present invention there is provided a system for initiating payments in favour of a payee entity, the system comprising a payment processor including: a receiving component for receiving, from a payee entity, an account creation request, the request including an identifier of a consumer; a registering component for registering a financial account for the payee entity in association with the consumer identifier; a providing component for providing a consumer-specific account identifier of the financial account; a linking component for linking the consumer-specific account identifier to the payee entity and consumer identifier; and, a communication component for transmitting the consumer-specific account identifier to a communication device of the consumer directly or via the payee entity so as to permit the consumer to initiate a payment in favour of the financial account of the payee entity by generating a transaction request message including the consumer-specific account identifier.

The payment processor may execute a software architecture in which a single instance of software serves multiple tenants, and wherein the payee entity is registered as a tenant.

The registering component may include a transmitting component for transmitting a request to an acquiring financial institution to register the financial account in association with the consumer identifier.

The payment processor may include: a transaction messaging component for receiving a transaction request message in respect of a transfer of funds from a financial account of the consumer to the payee entity, the transaction request message including the consumer-specific account identifier and an amount associated with the transfer of funds; an identifying component for identifying, using the consumer-specific account identifier, the financial account of the payee entity; and a processing component for processing the transfer of funds against the financial account of the consumer and in favour of the financial account of the payee entity.

The identifying component may use the consumer-specific account identifier to identify a payee entity identifier and the consumer identifier.

The identifying component may identify an acquiring financial institution having registered the financial account; and wherein the processing component includes the consumer identifier in the transaction request message and wherein the transaction messaging component transmits the transaction request message to the acquiring financial institution.

The transaction messaging component may receive a transaction response message from the acquiring financial institution, the transaction response message either confirming or denying the transaction.

The communication component is further for transmitting a payment confirmation message or payment denial message to the consumer.

A computer program product for initiating payments in favour of a payee entity, the computer program product comprising a computer-readable medium having stored computer-readable program code for performing the steps of: receiving, from a payee entity, an account creation request, the request including an identifier of a consumer; registering a financial account for the payee entity in association with the consumer identifier; providing a consumer-specific account identifier of the financial account; linking the consumer-specific account identifier to the payee entity and consumer identifier; and, transmitting the consumer-specific account identifier to a communication device of the consumer directly or via the payee entity so as to permit the consumer to initiate a payment in favour of the financial account of the payee entity by generating a transaction request message including the consumer-specific account identifier.

Further features provide for the computer-readable medium to be a non-transitory computer-readable medium and for the computer-readable program code to be executable by a processing circuit.

### BRIEF DESCRIPTION OF THE DRAWINGS

The invention will now be described, by way of example only, with reference to the accompanying representations in which:

FIG. 1A is schematic diagram which illustrates an exemplary system for initiating payments in favour of a payee entity according to one embodiment described herein;

FIG. 1B is a schematic diagram which illustrates an exemplary data record of a consumer;

FIG. 2A is a block diagram which illustrates components of the exemplary system illustrated in FIG. 1A;

FIG. 2B is a block diagram which illustrates an exemplary multi-tenancy architecture which may be provided by the payment processor described herein;

FIG. 3 is a swim-lane flow diagram which illustrates an exemplary method for initiating payments in favour of a payee entity;

FIG. 4 is a swim-lane flow diagram which illustrates an exemplary method in which an unbanked consumer is able to initiate payments in favour of a payee entity;

FIG. 5 is a flow diagram which illustrates an exemplary method of providing balance information to a consumer;

FIG. 6 is a schematic diagram which illustrates an exemplary system for processing financial transactions in which aspects of this disclosure may be implemented;

FIG. 7 illustrates an example of a computing device in which various aspects of the disclosure may be implemented; and,

FIG. 8 shows a block diagram of a communication device that may be used in embodiments of the disclosure.

### DETAILED DESCRIPTION WITH REFERENCE TO THE DRAWINGS

Systems and methods for initiating payments in favour of a payee entity are described herein. In some embodiments, a financial account of a payee entity is registered in association with a consumer. The consumer receives a consumer-specific account identifier which the consumer may use to initiate payments in favour of the financial account of the payee entity. In one example, the consumer may use a mobile communication device, such as a mobile phone, in order to generate a transaction request message, which includes the consumer-specific account identifier, so as to initiate the payment in favour of the payee entity.

The term “payee entity” may refer to a biller, such as a utility provider, fixed line or mobile phone provider, cable or satellite television provider and the like. A payee entity may also include a bill aggregator. It should be emphasized that in some embodiments, the financial account of a payee entity may be unique to a specific consumer. Thus, a payee entity having many consumers may have many financial accounts, each being associated with a respective consumer. However, in other embodiments, many consumers may be associated with a single financial account, with payments being made in favour of the financial account being recognizable as having originated from a specific consumer by a consumer reference included associated with the payment.

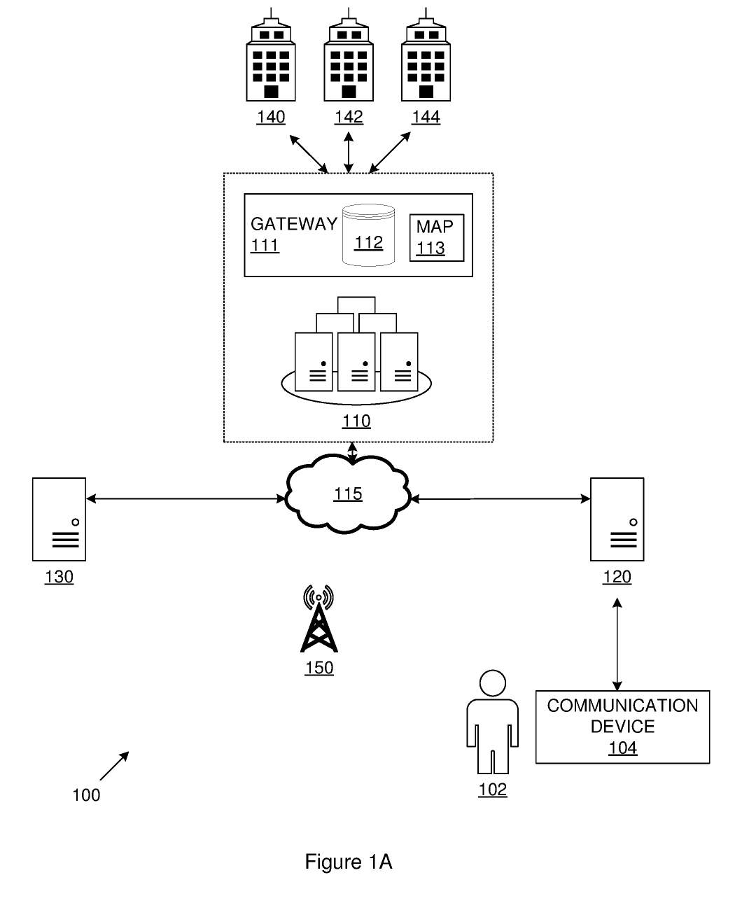

Embodiments of the described systems and methods are thus directed at reducing complexity and friction experienced by consumers in paying billers. FIG. 1A is schematic diagram which illustrates an exemplary system (100) for initiating payments in favour of a payee entity according to one embodiment.

The system (100) may include a consumer (102), a payment processor (110), a server computer (120) of an issuing financial institution, a server computer (130) of an acquiring financial institution, and a number of payee entities (140, 142, 144). It should be appreciated that in an implementation of the system there may be a plurality consumers, financial institution server computers and payee entities.

The consumer (102) may have a communication device (104) with which the consumer (102) may communicate with the issuing server computer (120) via an appropriate communication network (150). In some embodiments, the payment processor (110) may also be configured to communicate with the communication device (104). The communication device (104) may be a mobile communication device or any other appropriate electronic device capable of communicating over a communication network. Exemplary communication devices include mobile phones, smart phones, personal digital assistants, tablet computers, wearable computing devices, laptop or desktop computers, smart appliances and the like.

The communication device (104) may have a software application resident therein and installed thereon which may enable the communication device (104) to transmit data messages to and receive data messages from the issuing server computer (120) and/or payment processor (110). In other embodiments, the communication device (104) may exchange data messages with the issuing server computer (120) or payment processor (110) using Unstructured Supplementary Service Data (USSD) sessions or Short Messaging Service (SMS) messages via the communication network (150).

By enabling the communication device (104) to exchange messages with the issuing server computer (120), the consumer (102) may be able to use the communication device (104) to transact against a financial account of the consumer controlled by the issuing server computer (120). For example, the consumer may be able to initiate transactions in favour of a financial account of a payee entity (140, 142, 144), submit balance enquiries, request single-use or one-time-only payment credentials and the like.

The payment processor (110) may be any appropriate server computer, server computer cluster, cloud-based server computer or the like. The payment processor (110) may include a gateway (111) enabling mobile financial services transacted via consumers' communication devices (104) such as mobile phones. The gateway (111) may have access to a database (112) in which data records relating to a consumer may be stored.

The gateway (111) may include a mapping (113) of consumers' communication devices' communication addresses, such as a mobile subscriber integrated digital services network (MSISDN) number, to a primary account number (PAN) or token. A token may be used as an artificial account number stored and transmitted in place of a true account number.

The gateway (111) may have tenants in the form of issuing and acquiring financial institutions. Such institutions may have business identifiers (BIDs) with a corresponding bank identification number (BIN). In the described system, a payee entity (140, 142, 144) may be a sub-tenant of a tenant at the gateway (111) which has a billing BID as it will not have its own BID. A payee entity may have a sponsoring acquiring financial institution.

The mapping (113) may include mapping a PAN or token to an endpoint. In the described method and system an endpoint may be a payee entity with a consumer-specific account identifier. The payee entity with a consumer-specific account identifier permits the consumer to initiate a payment in favour of the payee entity by generating a transaction request message including the consumer-specific account identifier. The payee entity may be a biller as defined above or may be a biller aggregator. In the case of a biller aggregator, an endpoint may identify a biller and the consumer-specific account identifier.

The mapping (113) may be provided as a service to register consumers with a PAN or token.

A data record relating to a consumer is stored in the database (112). FIG. 1B is a schematic diagram which illustrates an exemplary data record (180) of a consumer. The data record (180) may have a number of consumer-specific account identifiers (182, 192) stored therein. Each consumer-specific account identifier may be for a different payee entity. For example one for a utility service provider and another for a pay television service provider.

Each of the consumer-specific account identifiers is linked with a consumer identifier (184, 194) and a payee entity identifier (186, 196) of an associated payee entity (e.g. 140, 142). The consumer identifier may be a consumer reference at the payee entity and/or may be usable by the associated payee entity to allocate payments received from the consumer. Each consumer specific account identifier may further be linked with account information relating to a financial account registered for the payee entity in association with the consumer. The account information may include a bank identification number (BIN) of an acquiring financial institution maintaining the relevant financial account as well as an account number of the financial account. Alternatively, the consumer-specific account identifier may point to the financial account.

The data record (180) may further include one or more of the group of: a communication address of the consumer's communication device, such as a mobile subscriber integrated digital services network (MSISDN) number; a payee entity reference; a statement relating to the financial account of the payee entity; balance information relating to the financial account of the payee entity; a business identifier (BID), and the like. In some embodiments, where the payee entity is a bill aggregator, the data record may further include information relating to the biller and a consumer reference for use by the biller in allocating payments received by the consumer.

Enabling payee entities such as billers and biller aggregators to have an endpoint at a payment processor (110) standardizes payments across a payment network and enables payments to go direct to the payee entity by tokenizing account references for payors.

Returning to FIG. 1A, the payment processor (110) may be configured to communicate with the issuing server computer (120), acquiring server computer (130) and the number of payee entities (140, 142, 144). In some embodiments, the payment processor (110) may form a part of or be adjunct to a payment processing network (115), such as VisaNet™ and the gateway (111) may form a mobile money processing gateway. In other embodiments, the payment processor may be hosted by a financial institution such as a bank.

The payment processing network (115) may include data processing subsystems, networks, server computers and operations used to support and deliver authorization services, exception file services, and clearing and settlement services. The payment processing network (115) may be any suitable network able to transmit and receive financial system transaction messages (e.g., ISO 8583 messages), and process original credit and debit card transactions. Payment processing systems such as VisaNet™ are able to process credit card transactions, debit card transactions, and other types of commercial transactions, including virtual card and mobile wallet transactions.

The server computers (120, 130) of the issuing and acquiring institutions respectively may be any appropriate server computers, server computer clusters, distributed server computers, cloud-based server computers and the like. Each of the server computers (120, 130) may include a processor and a non-transitory computer readable medium comprising code executable by the processor to perform functions, such as generating messages, electronically receiving and transmitting messages or data, parsing messages or data, and the like. The server computers (120, 130) may be configured to transmit and receive financial system transaction messages (such as ISO 8583 messages), debit and credit financial accounts and the like. The issuing server computer (120) may operate a financial account of the consumer while the acquiring server computer (130) may operate financial accounts of the payee entities (140, 142, 144). In some cases, payee entities may have a number of financial accounts, each being associated with a consumer.

Communications between the payment processor (110) and the server computers (120, 130) may be via financial system transaction messages and in some embodiments may utilize an appropriate International Standards Organization (ISO) messaging format, such as ISO 8583. Similarly, the communications between the payment processor (110) and the number of payee entities (140, 142, 144) may use the ISO 8583 messaging protocol or other similar messaging protocol. In some cases, the communications between the payment processor (110) and the number of payee entities (140, 142, 144) may be provided via an application programming interface (API) which the number of payee entities (140, 142, 144) can consume.

A transaction request message may be any suitable message transmitted from the issuing server computer (120) to the acquiring server computer (130) through the payment processor (110). A transaction request message may in the standard ISO 8583 messaging format, or in any other suitable financial system transaction messaging format. Suitable messages may be in an 0200 message format. In some embodiments, a transaction request message may include a transaction type indicator, a transaction identifier, an amount associated with the transfer of funds, information identifying the consumer such as a consumer identifier and the like.

In some embodiments, the transaction request message can be an OCT (Original Credit Transaction) type message. An OCT transaction is typically a clearing and settlement credit transaction designed for use in business applications such as a business money transfer or business-to-consumer repayments. In some cases, the OCT carries only the account number of the recipient and no information about the sender. A special indicator identifies an OCT to the recipient of the message. OCT messages may also include an Electronic Commerce Indicator (ECI) to indicate an Internet OCTs (if appropriate).

Some embodiments of the described systems and methods provide for transaction request messages, including the consumer-specific account identifier, to be routed from the issuing server computer (120) to the payment processor (110) and onwards to the acquiring server computer (130). The acquiring server computer (130) may then credit a relevant financial account and transmit a transaction response message, either confirming or denying the transaction, to the payment processor (110). This enables a payee entity to expose customer accounts for transactions that credit the account using ISO messaging or a gateway API.

Consumers may push OCT payments to payee entities from any system capable of allowing the consumer to capture an OCT without requiring the payee entities to be PCI compliant. For example, products such as Visa® Direct™ utilise OCT messages to enable consumers to send money to eligible accounts around the world. Other products, such as mVisa™, utilise OCT messages to enable consumers to send money to eligible accounts using the consumer's mobile phone. The systems and methods described herein anticipate utilising OCT messages to enable consumers to initiate payments in favour of payee entities by using a consumer-specific account identifier.

The transaction response message may be any suitable message transmitted from the acquiring server computer (130) to the payment processor (110) and optionally onwards to the issuing server computer (120). A transaction response message may be in the standard ISO 8583 messaging format, or in any other suitable financial system transaction messaging format. The transaction response message may be an 0210 message and may include an indication that the transfer of funds was approved or not approved.

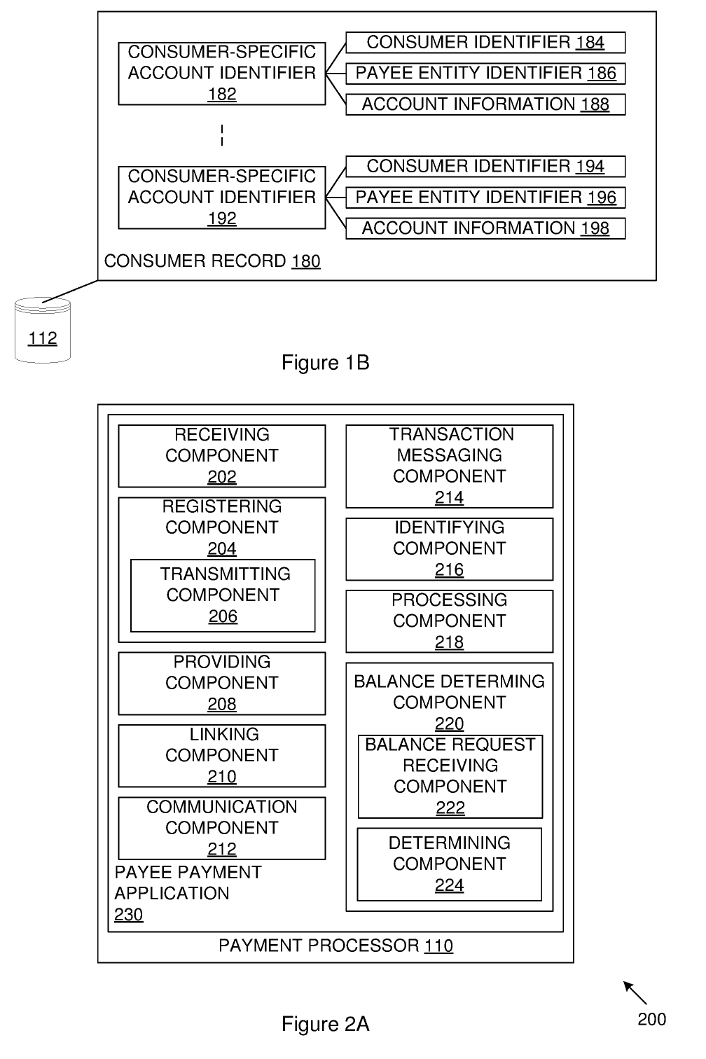

FIG. 2A is a block diagram which illustrates components of an exemplary system (200) for initiating payments in favour of a payee entity. The system (200) includes a payment processor (110) which may include or work in association with a gateway (111) as described in relation to FIG. 1A.

The payment processor (110) may include a receiving component (202) arranged to receive, from a payee entity, an account creation request. The request may include an identifier of a consumer. The consumer identifier may be used by the payee entity to allocate payments made by the consumer. The receiving component (202) may further be for one of: receiving a payee entity identifier with the account creation request or generating a payee entity identifier.

The payment processor (110) may further include a registering component (204) configured to register a financial account for the payee entity in association with the consumer identifier. In some embodiments, the registering component (204) may also include a transmitting component (206) arranged to transmit a request to an acquiring financial institution to register the financial account in association with the consumer identifier. In other cases, registering the financial account in association with the consumer identifier may establish an association between an existing financial account and the consumer identifier. In some embodiments, the financial account registered for the payee entity in association with the consumer identifier may be a financial account uniquely associated with (i.e. personal to) the consumer, meaning that only the consumer makes payment in favour of that particular account. In other embodiments, it may be a general account which is associated with one or more consumers.

The payment processor (110) may include a providing component (208) arranged to provide a consumer-specific account identifier of the financial account and a linking component (210), which may provide the functionality of the mapping (113) of FIG. 1A, for linking the consumer-specific account identifier to the payee entity and consumer identifier.

The linking component (210) may link the consumer-specific account identifier to the payee entity identifier and consumer identifier. The linking component (210) may further link the consumer-specific account identifier with details of the financial account registered for the payee entity in association with the consumer identifier although in other cases the consumer-specific account identifier may point to the financial account (e.g. usable in identifying the financial account). The consumer-specific account identifier may be in the form of a primary account number (PAN) and may include routing information such as a bank identification number (BIN) or similar. In some embodiments, the consumer-specific account identifier is a 16-digit PAN. The BIN may be a BIN of the acquiring financial institution or of the payment processor. For example, in some cases, the routing information may cause transaction request messages including the identifier to be routed to the payment processor. Alternatively, the BIN may be that of the payee entity and may be linked to the payee entity identifier.

A communication component (212) arranged to transmit the consumer-specific account identifier to the consumer may also be provided. The communication component (212) may transmit the consumer-specific account identifier to the communication device of the consumer directly (for example as an SMS or data message) or may transmit it to the consumer via the payee entity (for example for inclusion on an invoice). Upon receipt of the consumer-specific account identifier, the consumer may be able to initiate a payment in favour of the payee entity by generating a transaction request message including the consumer-specific account identifier. In some embodiments, the communication component (212) may also be configured to transmit a payment confirmation message or payment denial message to the consumer.

Some embodiments provide for the payment processor (110) to further include a transaction messaging component (214) arranged to receive a transaction request message in respect of a transfer of funds from a financial account of a consumer to a payee entity. The transaction request message may including the consumer-specific account identifier and an amount associated with the transfer of funds. The transaction messaging component (214) may receive the transaction request message from the issuing server computer via the payment processing network.

The transaction messaging component (214) may also be configured to transmit the transaction request message, which may include the consumer identifier, to an identified acquiring financial institution. The transaction messaging component (214) may also be arranged to receive a transaction response message from the acquiring financial institution. The transaction response message may either confirm or deny the transaction.

The payment processor (110) may further include an identifying component (216) configured to identify, using the consumer-specific account identifier, the financial account of the payee entity and a processing component (218) arranged to process the transfer of funds against the financial account of the consumer and in favour of the financial account of the payee entity.

In some embodiments, the identifying component (216) uses the consumer-specific account identifier to identify the payee entity identifier and the consumer identifier. The identifying component (216) may also identify an acquiring financial institution maintaining the financial account and/or details relating to the financial account. In some cases, the identifying component queries the database using the consumer-specific account identifier to identify the relevant information.

Further, the processing component (218) may include the consumer identifier and/or the payee entity identifier in the transaction request message before the transaction messaging component (214) transmits the transaction request message to the acquiring financial institution. Alternatively, the processing component (218) may not alter the transaction request message.

The processing component (218) may extract the amount from the transaction request message and update the corresponding consumer record stored in the database to reflect the payment made.

Some embodiments provide for the payment processor (110) to include a balance determining component (220). The balance determining component (220) may include a balance request receiving component (222) configured to receive an account balance request from a consumer, the request including the consumer identifier. The request may be received from the communication device of the consumer via the communication component (212). The balance determining component (220) may use the identifying component (216) for identifying a financial account associated with the consumer identifier included in the account balance request. A determining component (224) may be included in the balance determining component (220) for determining balance information of the financial account. The communication component (212) may then be used to transmit the balance information to the consumer.

In some embodiments the payment processor (110) executes a software architecture in which a single instance of software serves multiple tenants. The single instance of software may be provided by a payee payment application (230) which provides one or more or all of the components described above. FIG. 2B is a block diagram which illustrates such an exemplary multi-tenancy architecture which may be provided by the payment processor (110). The payee payment application (230) includes computer program code which is executable by one or more processors of the payment processor (110). The payee payment application (230) may enable or provide the functionality of the payment processor as described herein.

The payee payment application (230) serves multiple tenants, in this case being multiple payee entities (140, 142, 144). The payee entities (140, 142, 144) may access the payee payment application (230) remotely via, for example, the Internet or other appropriate communication network. Tenants may be given the ability to customise some parts of the application, such as business rules and the like.

Data (140A, 142A, 144A) for each of the payee entities (140, 142, 144), such as data records relating to consumers, is stored in the database (112). Each payee entity (e.g. 140) may be restricted to accessing their respective data (e.g. 140A) only. In this manner, each payee entity may create, update and delete data records by accessing the payee payment application (230) remotely.

The payee payment application (230) has access to a communication interface (232) and a payment processing network interface (234). The communication interface (232) is arranged to provide an interface between the communication component (212) and the communication network (150), so as to enable the payment processor (110) to communicate with the communication device (104).

The payment processing network interface (234) is arranged to provide an interface between the transaction messaging component (214) and the payment processing network (115) so as to enable communication between the payment processor (110) and the server computers (120, 130). The payment processing network interface (234) enables the payment processor (110) to transmit and receive financial system transaction messages (e.g. ISO 8583 messages) to and from the server computers (120, 130).

Payee entities are able to register as tenants of the payment processor (110). Once registered, payee entities can request, by remotely accessing the payee payment application (230), that a financial account be registered in association with a consumer and that a consumer-specific account identifier be linked to the payee entity and consumer identifier. The consumer-specific account identifier can be transmitted to a communication device of the consumer so as to permit the consumer to initiate a payment in favour of the financial account of the payee entity by generating a transaction request message including the consumer-specific account identifier. The payee entities may also be able to maintain and update consumer records, check balances of financial accounts registered for the payee entity, check a consumer's account balance information and the like.

The multi-tenancy architecture described above may obviate the need for each payee entity to implement or deploy their own software and/or hardware. Furthermore, updates need only be made to the payee payment application (230), rather than each payee's instance of an application.

It should be appreciated that in the methods described herein, some or all of the steps or operations carried out by the payment processor (110) may be executed by the payee payment application (230) executing on behalf of a payee entity registered as a tenant.

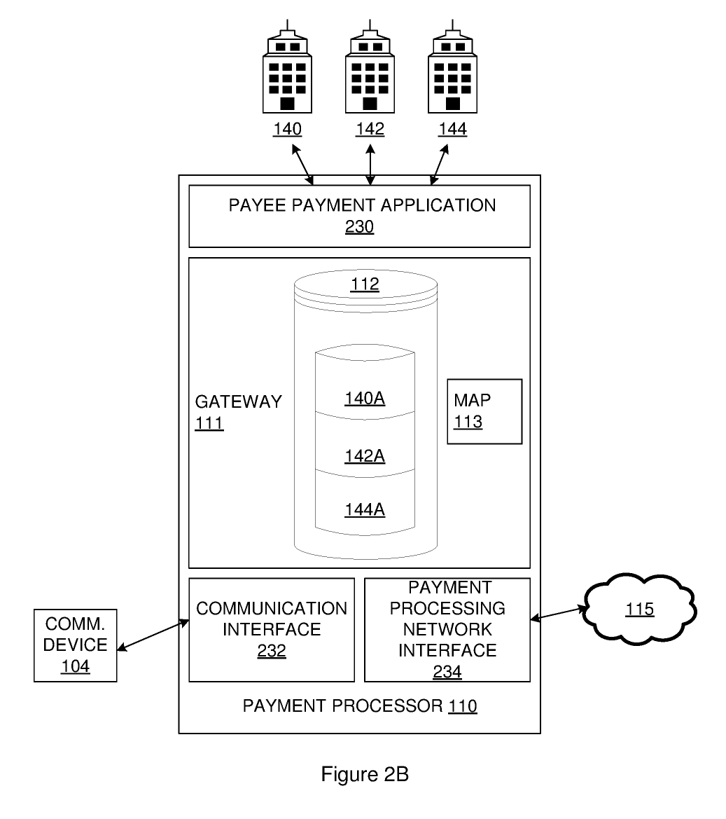

FIG. 3 is a swim-lane flow diagram which illustrates an exemplary method for initiating payments in favour of a payee entity.

At a first stage (302), the payment processor (110) may receive, from the payee entity (140), an account creation request including an identifier of a consumer in whose respect the account is to be created. In some embodiments, receiving an account creation request includes receiving a payee entity identifier with the account creation request while in other embodiments, the payment processor generates a payee entity identifier at a next stage. A virtual card component may be exposed by the payment processor (110) to allow a payee entity (140) to register a consumer account including an identifier of the consumer (for example, as a billing reference).

At a following stage (304), the payment processor (110) may register a financial account for the payee entity in association with the consumer identifier. In the described embodiment, the stage (304) of registering a financial account for the payee entity in association with the consumer identifier includes a stage (306) of transmitting a request to an acquiring server computer (130) of an acquiring financial institution to register the financial account in association with the consumer identifier, responsive to which, the acquiring server computer registers the financial account in a next stage (308). In another embodiment, registering a financial account in association with the consumer identifier may link an existing financial account with the consumer identifier. The registered financial account may be unique to the consumer or may be a general financial account used by a number of consumers.

The payment processor (110) may then, at a following stage (310), provide a consumer-specific account identifier of the financial account. This consumer-specific account identifier may be in the form of a primary account number (PAN) and may include routing information such as a bank identification number (BIN) or similar and may also be usable to identify the financial account. In some embodiments, the consumer-specific account identifier is a 16-digit PAN. The BIN may be a BIN of the acquiring financial institution. Alternatively, the BIN may be that of the payee entity and may be linked to or associated with the payee entity identifier. A token in the form of an artificial account number may be used instead of a PAN.

At a next stage (312), the payment processor (110) may link the consumer-specific account identifier to the payee entity and consumer identifier. This may include linking the consumer-specific account identifier to the payee entity identifier and consumer identifier in a database of the payment processor (110). In other cases, the consumer-specific account identifier may be associated with the consumer record in the database.

The payment processor (110) may then, at a next stage (314), transmit the consumer-specific account identifier to a communication device of the consumer so as to permit the consumer to initiate a payment in favour of the payee entity by generating a transaction request message including the consumer-specific account identifier. This may be directly transmitted to the communication device of the consumer (for example in an SMS or data message) using a registered communication device address such as an MSISDN of the consumer. Alternatively, the consumer-specific account identifier may be transmitted to the consumer via the payee entity.

At a later stage a consumer may wish to initiate a payment in favour of the payee entity using the consumer's communication device. The consumer may have received an invoice from the payee entity reflecting an amount owing for goods or services rendered. The invoice may include the consumer-specific account identifier. Alternatively, the consumer may have previously stored the consumer-specific account identifier. In order to do this, the consumer may transmit a transaction request, including the consumer-specific account identifier and an amount associated with the payment, to the issuing server computer (120) of the issuing financial institution using the consumer's communication device.

Responsive to receiving this request, the issuing server computer (120) may generate a transaction request message in respect of the transfer of funds from a financial account of the consumer to the payee entity at a next stage (316). The transaction request message may include the consumer-specific account identifier and an amount associated with the transfer of funds, such as $100.

At a following stage (318), the issuing server computer (120) may transmit the transaction request message to the payment processor (110). The transaction request message may be an appropriate financial system transaction message, such as ISO 8583 message and may be transmitted via a payment processing network. Routing information included in the consumer-specific account identifier may cause the transaction request message to be routed to the payment processor. At a next stage (320), the payment processor (110) receives the transaction request message, including the consumer-specific account identifier and an amount associated with the transfer of funds.

The payment processor (110) may then identify, using the consumer-specific account identifier, the financial account of the payee entity at a following stage (322). This may include using the consumer-specific account identifier to identify the payee entity identifier and the consumer identifier. In one embodiment, the consumer may automatically include their communication device address (for example, the MSISDN) by sending the request via a mobile channel. The mapping service of the payment processor (110) may convert the communication device address to the consumer-specific account identifier before forwarding the payment. The payee entity may be responsible for maintaining the consumer references in the mapping server (for example, creation, update, and delete). In some cases, identifying the financial account of the payee entity may include querying a database for a consumer record associated with the consumer-specific account identifier.

At a next stage (323), the payment processor (110) may process the transfer of funds against the financial account of the consumer and in favour of the financial account of the payee entity. This may include further stages of identifying an acquiring financial institution having registered the financial account and optionally including the consumer identifier in the transaction request message. The payment processor (110) may further update the consumer record to reflect the payment made by the consumer in favour of the financial account of the payee entity.

At a following stage (324), the payment processor (110) may transmit the transaction request message to the acquiring server computer (130) of the acquiring financial institution. The acquiring server computer (130) may then, at a following stage (326), receive the transaction request message, including the consumer-identifier. The acquiring server computer (130) may then credit the financial account of the payee entity and transmit a transaction response message, either confirming or denying the transaction, to payment processor (110) at a next stage (328).

The payment processor (110) may then, at a following stage (330), receive the transaction response message from the acquiring server computer (130), the transaction response message either confirming or denying the transaction. At a next stage (332), the payment processor (110) may, transmit a payment confirmation message or payment denial message to the consumer. In some embodiments, the payment processor (110) transmits the transaction response message received from the acquiring server computer (130) to the issuing server computer (120). In some cases, the issuing server computer (120) may transmit the payment confirmation message or payment denial message to the consumer.

The above description describes an embodiment in which a payment transaction is in the form of a push transaction. A payment transaction using the consumer-specific account identifier for payment to a payee entity may be in the form of a pull transaction in which a PAN or token is created which is merchant logged to enable the payee to pull funds as and when required. The PAN or token may be translated to a back end account.

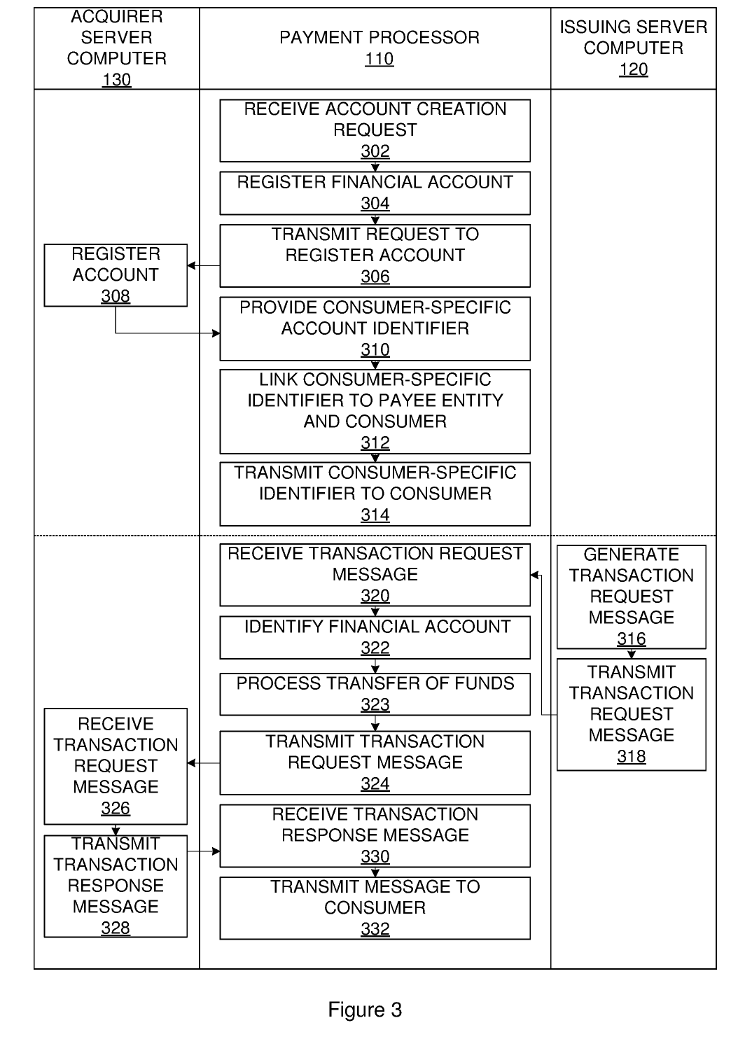

In some embodiments, the consumer may not have access to a financial account. FIG. 4 is a swim-lane flow diagram which illustrates an exemplary method in which a so-called “unbanked” consumer is able to initiate payments in favour of a payee entity.

In order to do this, the consumer may approach an agent having a float account against which the agent is able to conduct financial transactions on behalf of consumers. An exemplary agent is a mobile money agent. The consumer may provide the agent with the consumer's consumer-specific account identifier and request that the agent initiate a payment in favour or a financial account of the payee entity associated with the consumer.

The agent may use a communication device, such as a mobile phone, of the agent to transmit a transaction request from the float account of the agent and in favour of the payee entity account, including the consumer-specific account identifier and an amount associated with the transfer of funds, to an issuer server computer (120) of an issuing financial institution associated with the agent. At a first stage (402), the issuing server computer (110) may receive the transaction request and, at a following stage (404), may generate and transmit a transaction request message to the payment processor (110), including the consumer-specific account identifier and the amount associated with the transfer of funds.

The payment processor (110) may then receive the transaction request message in respect of the transfer of funds from the float account of the agent to a payee entity on behalf of a consumer at a following stage (406).

At a next stage (408), the payment processor may identify, using the consumer-specific account identifier, the financial account of the payee entity and an identifier of the consumer. At a following stage (410), the payment processor may process the transfer of funds against the float account and in favour of the financial account of the payee entity. This may include the payment processor updating a consumer record to reflect the payment made in favour of the financial account of the payee entity.

The payment processor (110) may then receive, at a following stage (412), a transaction response message either confirming or denying the transaction and may then, at a next stage (414), transmit a payment confirmation message or payment denial message to a communication device of the consumer such that the consumer may pay to the agent an amount of cash corresponding to the amount associated with the transfer of funds. Should the consumer receive the payment confirmation message, the consumer may pay the agent an amount of cash corresponding to the amount associated with the transfer of funds.

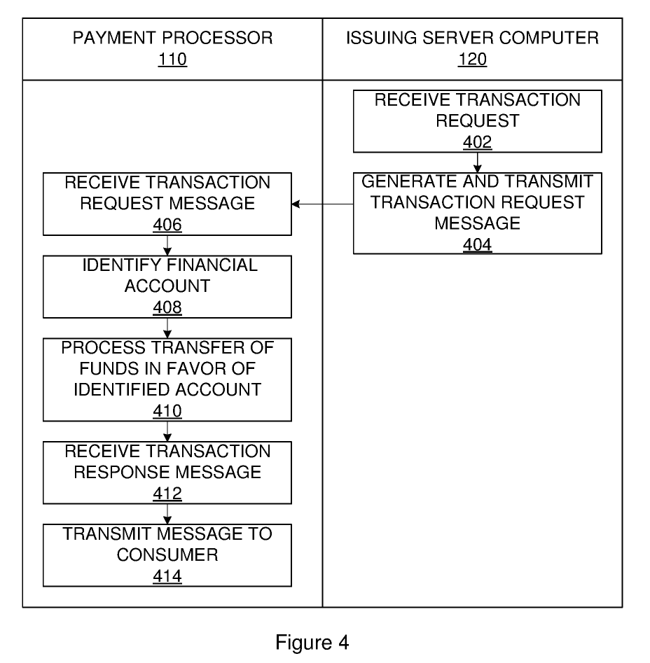

FIG. 5 is a flow diagram which illustrates another exemplary method (500) of providing balance information to a consumer. At a first stage (502), the payment processor may receive an account balance request from a consumer, the request including the consumer identifier. At a following stage (504), the payment processor may identify a financial account associated with the consumer identifier and, in a next stage (506), determine balance information of the financial account. The payment processor may then, at a following stage (508), transmit the balance information to the consumer.

Embodiments of the described systems and methods provide a generic way in which payee entities such as billers can expose consumer accounts (for transactions that will credit the account) using ISO messaging or an API. This may allow consumers to push payments to billers from any system capable of allowing the consumer to capture an OCT, without requiring the billers to be PCI compliant.

Embodiments provide functionality by way of which payee entities may register a consumer account (optionally with a billing reference) and obtain a consumer-specific account identifier. Consumers may then be able to remit funds to the payee entity using the consumer-specific account identifier that resolves to their account with the payee entity.

Advantages of the described systems and methods are that payee entities are not required to be PCI compliant. The registration of a consumer's payee entity account may include an MSISDN for direct delivery of the consumer-specific account identifier to the consumer. Delivery of this consumer-specific account identifier could be in the clear because it could only be validly used for transactions crediting the financial account of the payee entity associated with the consumer.

Furthermore, payee entities may be able to implement a subset of the standard ISO 8583 interface or an API to acquiring financial institutions rather than a bespoke interface. Further advantages may include a reduction in the errors that arise from payments to invalid or incorrect customer references. Further advantages of the described systems and methods include permitting the unbanked consumers, i.e. consumers not having financial accounts of their own, to pay payee entities through an agent.

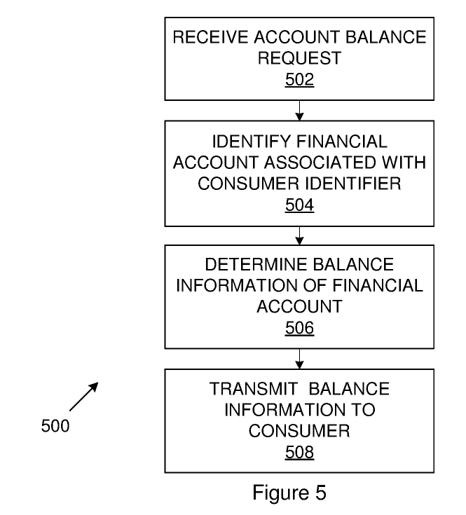

Referring to FIG. 6, a schematic diagram illustrates an exemplary system (600) for processing financial transactions in which aspects of this disclosure may be implemented. The system (600) includes a first server computer (610) associated with a first entity (612) (e.g. a consumer or a mobile money agent as described herein) and a second server computer (620) associated with a second entity (622). The first and second entity (612, 622) may also have a first entity device (614) and second entity device (624) respectively associated therewith. The first entity device (614) and the second entity device (624) may be mobile devices, such as mobile phones, of a payor and a payee.

The system (600) enables the first entity (612) to initiate payments in favour of the second entity (622) by causing transaction request messages, including a PAN of the second entity (622), to be generated and transmitted from the first server computer (610) to the second server computer (620). The system (600) may also include a payment processing network (630) via which the first server computer (610) may transmit and receive financial system transaction messages to and from the second server computer (620).

The first and second server computers (610, 620) respectively may be any appropriate server computers, server computer clusters, distributed server computers, cloud-based server computers and the like. Each of the server computers (610, 620) may include a processor and a non-transitory computer readable medium comprising code executable by the processor to perform functions, such as generating messages, electronically receiving and transmitting messages or data, parsing messages or data, and the like. The server computers (610, 620) may be configured to transmit and receive financial system transaction messages (such as ISO 8583 messages), debit and credit financial accounts, transmit messages to and receive messages from the first and second devices (614, 624) respectively and the like. The first server computer (610) may be maintained or operated by financial institution (616) controlling a financial account (618) of the first entity. Similarly, the second server computer may be maintained or operated by another financial institution (626) controlling a financial account (628) of the second entity (612).

The first entity device (614) may be any appropriate mobile device capable of communicating over a mobile communication network (650), such as a mobile phone. The first entity device (614) may have a mobile application resident therein and installed thereon which may enable the first entity device (614) to transmit data messages to and receive data messages from the first server computer (610). In other embodiments, the first entity device (614) may exchange data messages with the first server computer (610) using Unstructured Supplementary Service Data (USSD) sessions or Short Messaging Service (SMS) messages via the mobile communication network (650).

The second entity device (624) may also be an appropriate mobile communication device capable of communicating over a mobile communication network (650) such as a mobile phone. The second entity device (624) may also have an appropriate mobile software application resident therein and installed thereon which may enable the second entity device (624) to transmit data messages to and receive data messages from the second server computer (620). In other embodiments, the second entity device (624) may exchange data messages with the second server computer (620) using Unstructured Supplementary Service Data (USSD) sessions or Short Messaging Service (SMS) messages. In some embodiments, the second entity device (624) may be a merchant operated mobile communication device, a point-of-sales device, an e-commerce portal or the like.

By enabling the first entity device (614) to exchange messages with the first server computer (610), the first entity (612) may be able to use the first entity device (614) to transact against a financial account (618) of the first entity controlled by the first server computer (610). The first entity may be able to initiate transactions in favour of the second entity's financial account (628) by providing the second entity's payment information (e.g. a PAN). The second entity may provide its payment information to the first entity (612) by various means in the form of a token as described herein.

In response to receiving a request to initiate a transfer of funds in favour of the second entity's financial account (628), the first server computer (610) transmits a transaction request message, including the second entity identifier, to the second server computer (620) in order to debit the first entity account (618).

A transaction request message may be any suitable message transmitted from the first server computer (610) to the second server computer (620) through the payment processing network (630). A transaction request message may in the standard ISO 8583 messaging format, or in any other suitable financial system transaction messaging format. The transaction request message may be an OCT (Original Credit Transaction) type message.

The second entity identifier may include an issuer identification number (IIN) or BIN which is usable by the payment processing network (630) in identifying an appropriate financial institution (e.g. 126626) to which the transaction request message is to be transmitted. The first entity (612) may similarly have a first entity identifier associated therewith. The first entity identifier may include an IIN or BIN which is usable by the payment processing network (630) in identifying a financial institution (e.g. 116616) associated with the first entity (612).

The transaction request message may thus be routed from the payment processing network (630) to the second server computer (620). The second server computer (620) credits the second entity's financial account (628) and transmits a transaction response message, either confirming or denying the transaction, to the first server computer (610) via the payment processing network (630).

The system (600) described above may be utilised for person-to-person payments in which the first and second entities may be a payor and payee respectively. The system (600) may be utilised for consumer-to-merchant payments in which the second entity (a merchant) displays its second entity identifier to the first entity (a consumer) to enable the consumer to initiate payments in favour of the second entity. Furthermore, according to the systems and methods described herein, the system (600) may be utilised by a consumer wishing to pay a payee entity for services rendered. In such a case, the first entity may cause the first server computer to generate a transaction request message including the consumer-specific account identifier as well as an amount associated with the transfer of funds. The transaction request message may be sent by the first server computer to the payment processing network, which may route the message, based on the consumer-specific account identifier, to the payment processor (which may be a part of the payment processing network) for processing and completion of the transaction thereat. As mentioned above, in some embodiments, the consumer-specific account identifier points to a financial account registered for the payee entity in unique association with the consumer (i.e. a financial account which is personal to the consumer).

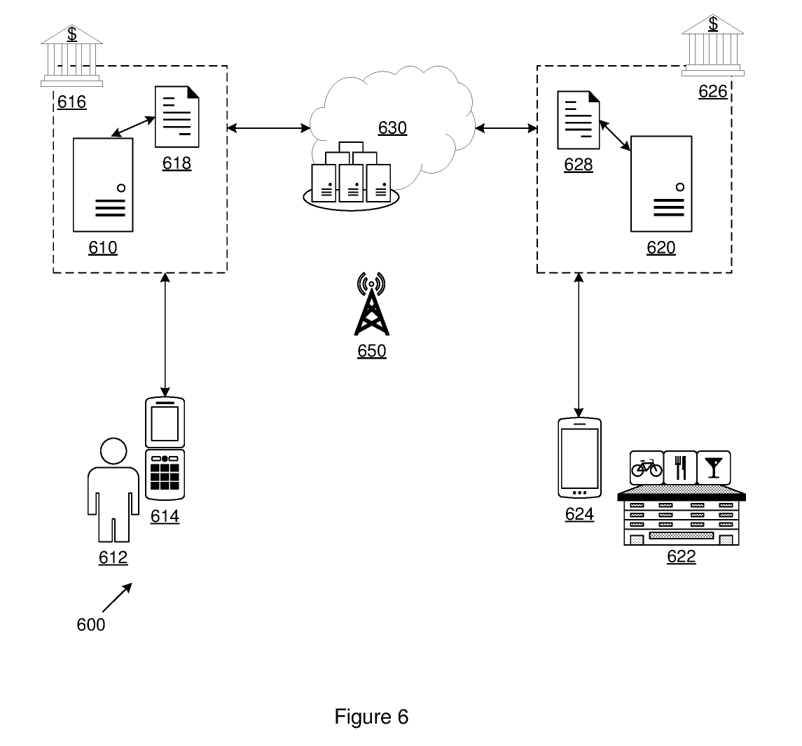

FIG. 7 illustrates an example of a computing device (700) in which various aspects of the disclosure may be implemented. The computing device (700) may be suitable for storing and executing computer program code. The various participants and elements in the previously described system diagrams may use any suitable number of subsystems or components of the computing device (700) to facilitate the functions described herein.

The computing device (700) may include subsystems or components interconnected via a communication infrastructure (705) (for example, a communications bus, a cross-over bar device, or a network). The computing device (700) may include at least one central processor (710) and at least one memory component in the form of computer-readable media.

The memory components may include system memory (715), which may include read only memory (ROM) and random access memory (RAM). A basic input/output system (BIOS) may be stored in ROM. System software may be stored in the system memory (715) including operating system software.

The memory components may also include secondary memory (720). The secondary memory (720) may include a fixed disk (721), such as a hard disk drive, and, optionally, one or more removable-storage interfaces (722) for removable-storage components (723). The removable-storage interfaces (722) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive. The removable-storage interfaces (722) may also be in the form of ports or sockets for interfacing with other forms of removable-storage components (723) such as a flash memory drive, external hard drive, or removable memory chip, etc.

The computing device (700) may include an external communications interface (730) for operation of the computing device (700) in a networked environment enabling transfer of data between multiple computing devices (700). Data transferred via the external communications interface (730) may be in the form of signals, which may be electronic, electromagnetic, optical, radio, or other types of signal.

The external communications interface (730) may enable communication of data between the computing device (700) and other computing devices including servers and external storage facilities. Web services may be accessible by the computing device (700) via the communications interface (730). The external communications interface (730) may also enable other forms of communication to and from the computing device (700) including, voice communication, near field communication, Bluetooth™, etc.

The computer-readable media in the form of the various memory components may provide storage of computer-executable instructions, data structures, program modules, and other data. A computer program product may be provided by a computer-readable medium having stored computer-readable program code executable by the central processor (710). A computer program product may be provided by a non-transient computer-readable medium, or may be provided via a signal or other transient means via the communications interface (730).

Interconnection via the communication infrastructure (705) allows a central processor (710) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (700) either directly or via an I/O controller (735). These components may be connected to the computing device (700) by any number of means known in the art, such as a serial port. One or more monitors (745) may be coupled via a display or video adapter (740) to the computing device (700).

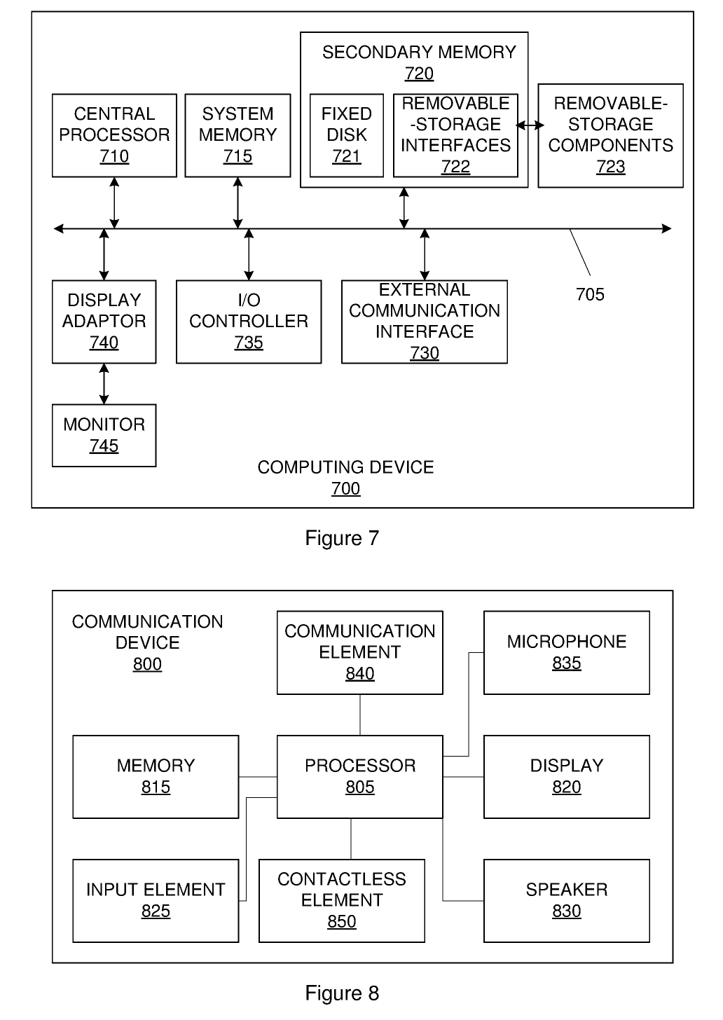

FIG. 8 shows a block diagram of a communication device (800) that may be used in embodiments of the disclosure. The communication device (800) may be a cell phone, a feature phone, a smart phone, a satellite phone, or a computing device having a phone capability.

The communication device (800) may include a processor (805) (e.g., a microprocessor) for processing the functions of the communication device (800) and a display (820) to allow a user to see the phone numbers and other information and messages. The communication device (800) may further include an input element (825) to allow a user to input information into the device (e.g., input buttons, touch screen, etc.), a speaker (830) to allow the user to hear voice communication, music, etc., and a microphone (835) to allow the user to transmit his or her voice through the communication device (800).

The processor (810) of the communication device (800) may connect to a memory (815). The memory (815) may be in the form of a computer-readable medium that stores data and, optionally, computer-executable instructions. The communication device (800) may also include a communication element (840) for connection to communication channels (e.g., a cellular telephone network, data transmission network, Wi-Fi™ network, satellite-phone network, Internet network, Satellite Internet Network, etc.). The communication element (840) may include an associated wireless transfer element, such as an antenna.

The communication element (840) may include a subscriber identity module (SIM) in the form of an integrated circuit that stores an international mobile subscriber identity and the related key used to identify and authenticate a subscriber using the communication device (800). One or more subscriber identity modules may be removable from the communication device (800) or embedded in the communication device (800).

The communication device (800) may further include a contactless element (850), which is typically implemented in the form of a semiconductor chip (or other data storage element) with an associated wireless transfer element, such as an antenna. The contactless element (850) may be associated with (e.g., embedded within) the communication device (800) and data or control instructions transmitted via a cellular network may be applied to the contactless element (850) by means of a contactless element interface (not shown). The contactless element interface may function to permit the exchange of data and/or control instructions between mobile device circuitry (and hence the cellular network) and the contactless element (850).

The contactless element (850) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth™, infra-red, or other data transfer capability that can be used to exchange data between the communication device (800) and an interrogation device. Thus, the communication device (800) may be capable of communicating and transferring data and/or control instructions via both a cellular network and near field communications capability.

The data stored in the memory (815) may include: operation data relating to the operation of the communication device (800), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (800) to selected receivers.

The communication device (800) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

It should be appreciated that components or modules described herein may have the required configuration and/or arrangement of hardware, software, firmware or the like for performing their associated functions, steps, processes and/or operations. The software components or functions described in this application may be implemented as software code to be executed by one or more processors using any suitable computer language such as, for example, Java™, C++, or Perl™ using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method for initiating payments in favour of a payee entity, the method being conducted at a payment processor and comprising:
receiving, from a payee entity, an account creation request, the request including an identifier of a consumer;
registering a financial account for the payee entity in association with the consumer identifier;
providing a consumer-specific account identifier of the financial account;
linking the consumer-specific account identifier to the payee entity and consumer identifier; and,
transmitting the consumer-specific account identifier to a communication device of the consumer directly or via the payee entity so as to permit the consumer to initiate a payment in favour of the financial account of the payee entity by generating a transaction request message including the consumer-specific account identifier.

2. The method as claimed in claim 1, wherein receiving an account creation request includes one of: receiving a payee entity identifier with the account creation request or generating a payee entity identifier.

3. The method as claimed in claim 1, wherein the payment processor executes a software architecture in which a single instance of software serves multiple tenants, and wherein the method includes registering the payee entity as a tenant.

4. The method as claimed in claim 1, wherein registering a financial account for the payee entity in association with the consumer identifier transmits a request to an acquiring financial institution to register the financial account in association with the consumer identifier.

5. The method as claimed in claim 1, wherein the method includes:
receiving a transaction request message in respect of a transfer of funds from a financial account of the consumer to the payee entity, the transaction request message including the consumer-specific account identifier and an amount associated with the transfer of funds;
identifying, using the consumer-specific account identifier, the financial account of the payee entity; and
processing the transfer of funds against the financial account of the consumer and in favour of the financial account of the payee entity.

6. The method as claimed in claim 1, wherein the consumer-specific account identifier includes routing information and wherein payments made in favour of the financial account of payee entity are routed via a payment processing network.

7. The method as claimed in claim 5, wherein identifying the financial account of the payee entity includes using the consumer-specific account identifier to identify a payee entity identifier and the consumer identifier.

8. The method as claimed in claim 5, wherein processing the transfer of funds includes:
identifying an acquiring financial institution having registered the financial account; including the consumer identifier in the transaction request message; and, transmitting the transaction request message to the acquiring financial institution.

9. The method as claimed in claim 8, wherein the method includes receiving a transaction response message from the acquiring financial institution, the transaction response message either confirming or denying the transaction.

10. The method as claimed in claim 5, wherein the method includes a step of transmitting a payment confirmation message or payment denial message to the consumer.

11. The method as claimed in claim 1, wherein the method further includes:
receiving an account balance request from the consumer, the request including the consumer identifier;
identifying the financial account associated with the consumer identifier;
determining balance information of the financial account; and,
transmitting the balance information to the consumer.

12. The method as claimed in claim 1, wherein the method includes:
receiving a transaction request message in respect of a transfer of funds from a float account of an agent to the payee entity on behalf of the consumer, the transaction request message including the consumer-specific account identifier and an amount associated with the transfer of funds;
identifying, using the consumer-specific account identifier, the financial account of the payee entity and an identifier of the consumer;
processing the transfer of funds against the float account and in favour of the financial account of the payee entity;
receiving a transaction response message either confirming or denying the transaction; and,
transmitting a payment confirmation message or payment denial message to the communication device of the consumer such that the consumer may pay to the agent an amount of cash corresponding to the amount associated with the transfer of funds.

13. A system for initiating payments in favour of a payee entity, the system comprising a payment processor including:
a receiving component for receiving, from a payee entity, an account creation request, the request including an identifier of a consumer;
a registering component for registering a financial account for the payee entity in association with the consumer identifier;
a providing component for providing a consumer-specific account identifier of the financial account;
a linking component for linking the consumer-specific account identifier to the payee entity and consumer identifier; and,
a communication component for transmitting the consumer-specific account identifier to a communication device of the consumer directly or via the payee entity so as to permit the consumer to initiate a payment in favour of the financial account of the payee entity by generating a transaction request message including the consumer-specific account identifier.

14. The system as claimed in claim 13, wherein the payment processor executes a software architecture in which a single instance of software serves multiple tenants, and wherein the payee entity is registered as a tenant.

15. The system as claimed in claim 13, wherein the registering component includes a transmitting component for transmitting a request to an acquiring financial institution to register the financial account in association with the consumer identifier.

16. The system as claimed in claim 13, wherein the payment processor includes:
a transaction messaging component for receiving a receiving a transaction request message in respect of a transfer of funds from a financial account of the consumer to the payee entity, the transaction request message including the consumer-specific account identifier and an amount associated with the transfer of funds;
an identifying component for identifying, using the consumer-specific account identifier, the financial account of the payee entity; and
a processing component for processing the transfer of funds against the financial account of the consumer and in favour of the financial account of the payee entity.

17. The system as claimed in claim 16, wherein the identifying component uses the consumer-specific account identifier to identify a payee entity identifier and the consumer identifier.

18. The system as claimed in claim 16, wherein the identifying component identifies an acquiring financial institution having registered the financial account; wherein the processing component includes the consumer identifier in the transaction request message and wherein the transaction messaging component transmits the transaction request message to the acquiring financial institution.

19. The system as claimed in claim 18, wherein the transaction messaging component receives a transaction response message from the acquiring financial institution, the transaction response message either confirming or denying the transaction.

20. A computer program product for initiating payments in favour of a payee entity, the computer program product comprising a computer-readable medium having stored computer-readable program code for performing the steps of:
receiving, from a payee entity, an account creation request, the request including an identifier of a consumer;
registering a financial account for the payee entity in association with the consumer identifier;
providing a consumer-specific account identifier of the financial account;
linking the consumer-specific account identifier to the payee entity and consumer identifier; and,
transmitting the consumer-specific account identifier to a communication device of the consumer directly or via the payee entity so as to permit the consumer to initiate a payment in favour of the financial account of the payee entity by generating a transaction request message including the consumer-specific account identifier.
